(19) United States
(12) Patent Application Publication
(10) Pub. No.: US 2010/0284611 A1
(43) Pub. Date: Nov. 11, 2010

(54) IMAGE SENSOR AND IMAGE SENSING METHOD FOR CHARACTER RECOGNITION

(75) Inventors: Byoung-Su Lee, Yeosu-si (KR); Hee-Chan Shin, Suwon-si (KR); Sung-Woong Han, Guri-si (KR); Dong-Yeol Kim, Seongnam-si (KR)

Correspondence Address: Jae Y. Park, Kile, Park, Reed & McManus, PLLC, 1200 New Hampshire Ave. NW, Suite 570, Washington, DC, 20036, US

(73) Assignee: SILICONFILE TECHNOLOGIES INC., Seoul (KR)

(21) Appl. No.: 12/773,417

(22) Filed: May 4, 2010

(30) Foreign Application Priority Data
May 7, 2009 (KR) 10-2009-0039556

(51) Int. Cl. G06K 9/00; H04N 5/228

(52) U.S. Cl. 382/165; 348/222.1

(57) ABSTRACT

A system for recognizing a text image in an image photographed by an image sensor as characters, searching the characters in an electronic dictionary, and displaying a search result on a window. The image sensor includes a photographing section configured to photograph an image; a determination section configured to determine the photographed image as at least one of a text image region and a non-text image region; and a conversion section configured to convert information of the determined text image region into binary information.

### BACKGROUND OF THE INVENTION

1. Field of the Invention

The present invention relates to image processing, and more particularly, to an image sensor and an image sensing method for character recognition, in which non-text information of a certain image region is removed and only monochrome text information devoid of colors is extracted.

2. Description of the Related Art

Currently, a mobile terminal such as a mobile phone, a PDA and a notebook computer is attached with a miniature camera. In particular, the uses of the mobile phone as a personal communication equipment which is always carried by a person have been remarkably diversified.

For example, when a user reads a foreign language book, by photographing the image of an unknown word by using the camera attached to the mobile phone, a character recognition system of the mobile phone can extract characters from the photographed image. The characters extracted in this way are searched in an electronic dictionary, and the meaning of the word is outputted to a display window of the mobile phone.

FIG. 1 is a block diagram illustrating a conventional mobile phone for character recognition, in which characters are extracted from an image photographed by the camera of the mobile phone, are searched in an electronic dictionary, and are outputted to a display window.

Referring to FIG. 1, a conventional mobile phone 100 for character recognition includes a camera 110 configured to photograph an image, a memory 120 configured to store the image photographed by the camera 110, a control unit 130 configured to extract a text from the stored image and recognize characters, an electronic dictionary 140 configured to allow the meaning of the text recognized as the characters by the control unit 130 to be searched, and a display unit 150 configured to display the contents searched in the electronic dictionary 140.

The conventional mobile phone 100 for character recognition configured as shown in FIG. 1 operates as described below.

First, a user photographs a word to be figured out in its meaning by using the camera 110.

The image of the word photographed in this way is stored in the memory 120, and is transmitted to the control unit 130 for character recognition.

Preferably, the control unit 130 is included in the central processing unit of the mobile phone 100.

The control unit 130 divides a text and a non-text from the photographed color (RGB) image, and recognizes the divided text as characters.

Then, the electronic dictionary 140 receives and searches the text recognized as the characters.

Finally, the display unit 150 displays the meaning of the searched text on the display window of the mobile phone 100 so as to be recognized by the user.

However, in the conventional mobile phone 100 for character recognition, a problem is caused in that, since the image inputted to the memory 120 is a color (RGB) image, the size of the input data is large.

Due to this fact, the processing speed of the central processing unit of the mobile phone 100 is decreased, a load increases, and a chip size is augmented.

### SUMMARY OF THE INVENTION

Accordingly, the present invention has been made in an effort to solve the problems occurring in the related art, and an object of the present invention is to provide an image sensor and an image sensing method for character recognition, in which an amount of data to be processed by a central processing unit of a terminal for character recognition and a load are decreased so as to increase a processing speed and reduce a chip size of the central processing unit.

In order to achieve the above object, according to one aspect of the present invention, there is provided a system for recognizing a text image in an image photographed by an image sensor as characters, searching the characters in an electronic dictionary, and displaying a search result on a window, the image sensor comprising a photographing section configured to photograph an image; a determination section configured to determine the photographed image as at least one of a text image region and a non-text image region; and a conversion section configured to convert information of the determined text image region into binary information.

Preferably, the determination section removes the non-text image region when the determination section determines the non-text image region.

Preferably, conversion into binary information is implemented by removing color (RGB) information from the determined text image region and converting the determined text image region into a monochrome image.

In order to achieve the above object, according to another aspect of the present invention, there is provided a method for image-sensing a photographed image, recognizing a text image in the image as characters, searching the characters in an electronic dictionary, and displaying a search result on a display window, the image-sensing comprising a photographing step in which the text image is placed in a specified area on a preview display window; a determining step in which at least one of a text image region and a non-text image region is determined from the photographed image; and a converting step in which information of the determined text image region is converted into binary information.

Preferably, the specified area corresponds to a center portion of the display window.

Preferably, the determining step comprises a removing step in which the non-text image region is removed when it is determined.

Preferably, conversion into binary information is implemented by removing color (RGB) information from the determined text image region and converting the determined text image region into a monochrome image.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram illustrating a conventional mobile phone for character recognition, in which characters are extracted from an image, are searched in an electronic dictionary, and are outputted to a display window;

FIG. 2 is a block diagram schematically illustrating a terminal which includes an image sensor for character recognition in accordance with an embodiment of the present invention;

FIG. 3 is a block diagram illustrating the configuration of the image sensor for character recognition in accordance with the embodiment of the present invention; and

FIG. 4 is a flow chart illustrating an image sensing method for character recognition in accordance with another embodiment of the present invention.

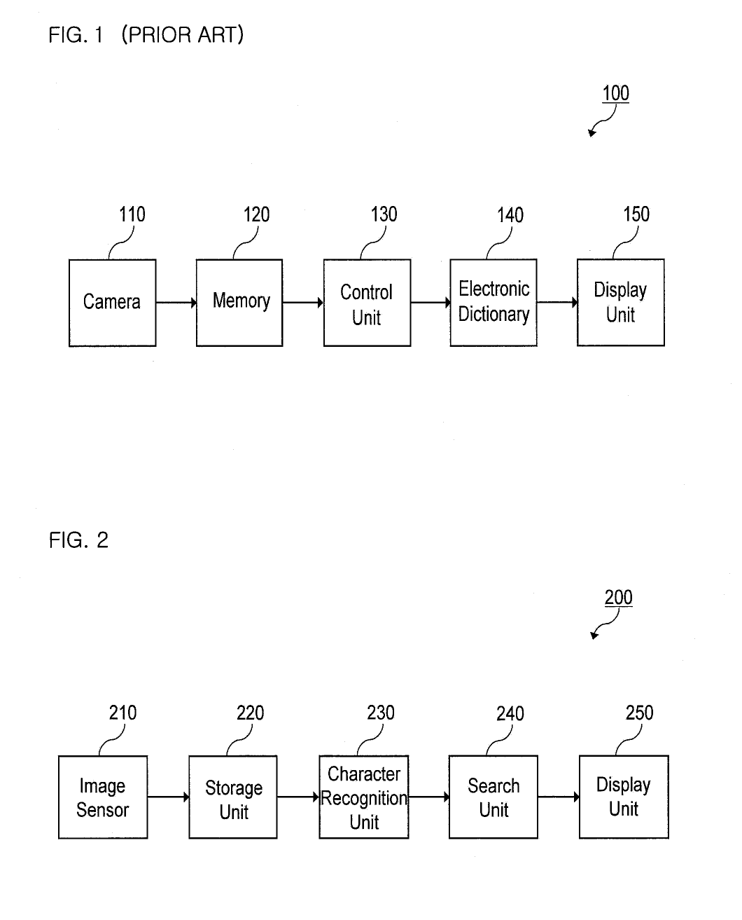

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

The basic principle of the present invention resides in that only the data determined as a text region in a photographed image region is binary-converted into a monochrome image devoid of color (RGB) information.

In the following description of the present invention, detailed explanations of known functions and configurations associated herewith will be omitted when they can make the subject matter of the present invention rather unclear.

Here, it is assumed that a terminal device or a terminal used in an embodiment of the present invention is a mobile phone.

Also, a text means printed characters or numbers, and a non-text means a picture or an empty image region excluding the text.

FIG. 2 is a block diagram schematically illustrating a terminal which includes an image sensor for character recognition in accordance with an embodiment of the present invention.

Referring to FIG. 2, a terminal 200 which includes an image sensor for character recognition in accordance with an embodiment of the present invention includes an image sensor 210 configured to recognize a specified image region, extract a text and binary-convert the extracted text, a storage unit 220 configured to store binary-converted information, a character recognition unit 230 configured to extract a text from the stored information and recognize the extracted text as characters, a search unit 240 configured to search the text recognized as characters in an electronic dictionary, and a display unit 250 configured to display searched contents on a display window.

The terminal 200 including the image sensor for character recognition in accordance with the embodiment of the present invention, configured as shown in FIG. 2, operates as described below.

First, the image sensor 210 photographs an image region which includes at least any one of a text image or a non-text image.

Thereafter, a text image region is determined, and the determined text image region is binary-converted into a monochrome image devoid of colors (RGB).

In general, an image is a picture which is produced or copied in an electronic pattern and is then stored. Here, the text does not have a text type but has a picture type as a subject for character recognition. That is to say, the image information photographed by the image sensor 210 has a color type.

However, because a text can be recognized as monochrome information, the text is converted into monochrome information by removing color information.

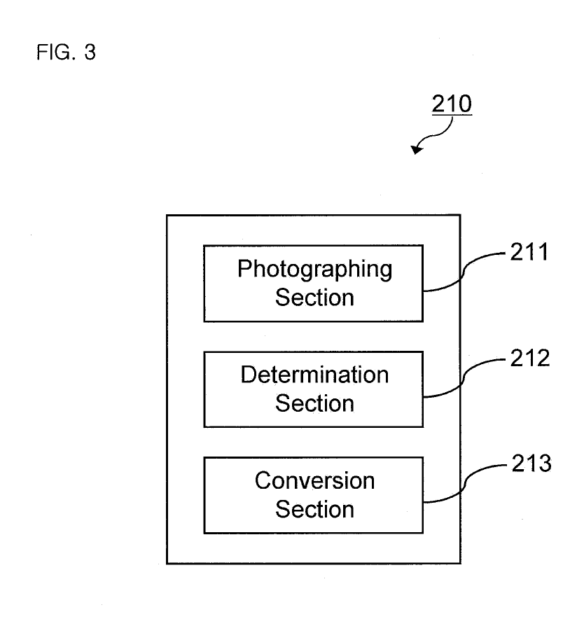

The configuration of the image sensor 210 is illustrated in detail in FIG. 3.

FIG. 3 is a block diagram illustrating the configuration of the image sensor 210 for character recognition in accordance with the embodiment of the present invention.

Referring to FIG. 3, the image sensor 210 for character recognition in accordance with the embodiment of the present invention includes a photographing section 211 configured to photograph an image, a determination section 212 configured to determine a text image region and a non-text image region from the photographed image, and a conversion section 213 configured to convert the information of the determined text image region into binary information.

The image sensor 210 for character recognition in accordance with the embodiment of the present invention, configured as shown in FIG. 3, operates as described below.

First, the photographing section 211 photographs an image region which includes at least any one of a text image or a non-text image.

As described above, the text includes printed characters of various fonts, numbers or symbols, and the non-text image is an image excluding the text image.

In the present invention, since the main function of an electronic dictionary is to search, the text image is limited to characters.

The image region photographed by the photographing section 211 is displayed on the display unit 250 under a preview mode.

Preferably, the preview mode represents a mode in which the image region photographed by the photographing section 211 is displayed in real time on the display window of the display unit 250.

That is to say, a user can place a desired text image region or an image region including a desired text among the image regions photographed by the photographing section 211, in a predetermined area on the display window of the mobile terminal under the preview mode.

Preferably, it is appropriate that the predetermined area on the display window of the mobile terminal corresponds to the center portion of the display window.

In this way, as the user places the image photographed by the photographing section 211 on the center portion of the display window under the preview mode, the determination section 212 can determine the text image and the non-text image from the image.

The non-text image determined in this way is removed, and the text image is binary-converted.

Preferably, the non-text image means not the text image but a graphic image or an empty image region.

Here, an example in which the images are removed and binary-converted will be described below.

First, an empty image region which does not include pixel information in the photographed image is removed.

Thereafter, a graphic image region is removed.

In general, a graphic image region has uniform color (RGB) information over a specified area of the display window.

That is to say, because a text is clearly divided into a region which has information over a certain area and a region (empty image region) which does not have information, if color information uniformly exists in a specified area, the corresponding area is determined to be the graphic region and is removed.

Accordingly, only the text image region remains.

Then, the conversion section 213 binary-converts the text image region.

An example of the binary conversion will be described below.

First, since the text image region has RGB color information, the text image region is binary-converted into a monochrome image devoid of the color information.

In this way, by converting RGB color text pixel information into binary information of 0 or 1, an amount of text data can be significantly reduced. For example, in the case where RGB is composed of 8 bits, one pixel has a size of 3×8 bits =24 bits. When the RGB is binary-converted to have two values of 0 and 1 (corresponding to black and white of a text), only 1 bit is used. Therefore, an amount of data can be reduced to 1/24.

Accordingly, the information of the text image region outputted from the image sensor 210 is decreased in its data size when compared to the information of the initially photographed image region, and an amount of a memory for storing the information is also reduced. Hence, since an amount of data to be processed by an algorithm for extracting characters from an image is reduced, a processing speed can be increased.

In succession, descriptions will be made with reference to FIG. 2.

The information of the binary-converted text image region outputted from the image sensor 210 is stored in the storage unit 220.

Thereupon, the character recognition unit 230 recognizes the information of the binary-converted text region which is stored as described above, as characters, converts the characters into a text capable of being electronically recognized, and transmits the converted text to the search unit 240.

The search unit 240 searches the converted text in an electronic dictionary, and transmits outputted contents to the display window of the display unit 250.

Preferably, the display unit 250 can display the outputted search contents on a preselected area or the entire area of the display window.

Further, the outputted search contents can be outputted by voice through a speaker.

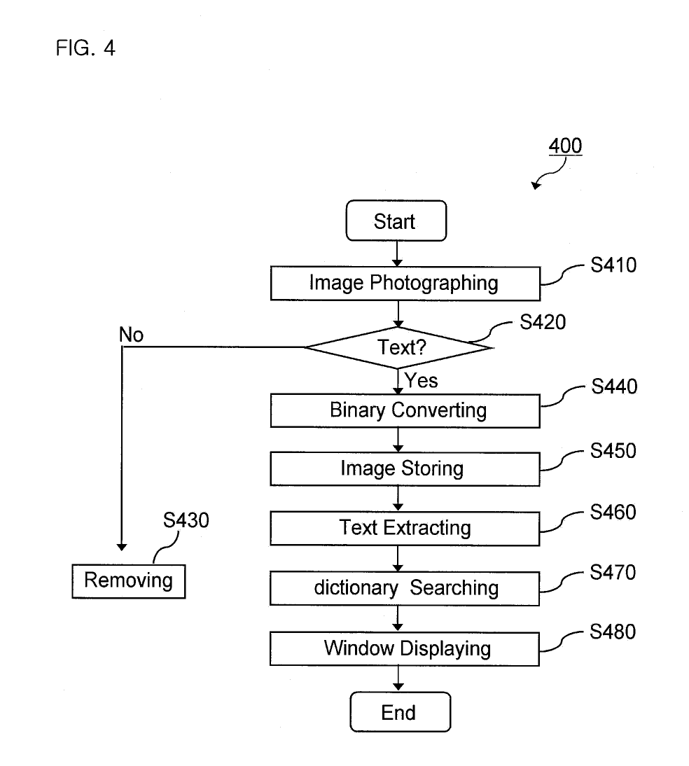

FIG. 4 is a flow chart illustrating an image sensing method for character recognition in accordance with another embodiment of the present invention.

Referring to FIG. 4, in an image sensing method 400 for character recognition in accordance with another embodiment of the present invention, an image region including at least one of a text region and a non-text region, which is selected by a user, is photographed (S410).

In general, an image is a picture which is produced or copied in an electronic pattern and is then stored.

Accordingly, the text does not have a text type but has a picture type as a subject for character recognition.

Meanwhile, the user moves the position of a mobile terminal such that a target text image among the regions displayed on the display window of the mobile terminal can be placed on the center portion of the display window under a preview mode.

If the text image is positioned on the center portion of the mobile terminal, a photographed image is determined as a text image region and a non-text image region (S420).

As a result of the determination, in the region determined as the non-text image region, a region which does not have pixel information is removed, and a region which is determined as a graphic image is removed (S430).

In general, a graphic image region has uniform color (RGB) information over a specified area of the display window.

That is to say, because a text is clearly divided into a region which has information over a certain area and a region (empty image region) which does not have information, if color information uniformly exists in a specified area, the corresponding area is determined to be the graphic region and is removed.

Accordingly, only the text image region finally remains.

Then, the remaining text image region is converted into binary monochrome information devoid of colors (RGB) as pixel information (S440).

The information converted in this way is transmitted to an outside and stored (S450), and a text is extracted from the stored binary information (S460).

Since the extracted text has a text type capable of being recognized in an electronic dictionary, the extracted text is searched in the electronic dictionary (S470), and the searched information is transmitted to and displayed on the display window of the mobile terminal (S480).

The searched information can be displayed on a preselected area or the entire area of the display window, and can be outputted as voice.

As is apparent from the above description, in the present invention, since an amount of data to be processed by a central processing unit of a terminal for character recognition is significantly decreased, a load can be reduced.

Also, due to this fact, the processing speed of the central processing unit of the terminal can be increased, and a chip size can be reduced.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A system for recognizing a text image in an image photographed by an image sensor as characters, searching the characters in an electronic dictionary, and displaying a search result on a window, the image sensor comprising:
a photographing section configured to photograph an image;
a determination section configured to determine the photographed image as at least one of a text image region and a non-text image region; and
a conversion section configured to convert information of the determined text image region into binary information.

2. The image sensor according to claim 1, wherein the determination section removes the non-text image region when the determination section determines the non-text image region.

3. The image sensor according to claim 1, wherein conversion into binary information is implemented by removing color (RGB) information from the determined text image region and converting the determined text image region into a monochrome image.

4. A method for image-sensing a photographed image, recognizing a text image in the image as characters, searching the characters in an electronic dictionary, and displaying a search result on a display window, the image-sensing comprising:
a photographing step in which the text image is placed in a specified area on a preview display window;
a determining step in which at least one of a text image region and a non-text image region is determined from the photographed image; and
a converting step in which information of the determined text image region is converted into binary information.

5. The method according to claim 4, wherein the specified area corresponds to a center portion of the display window.

6. The method according to claim 4, wherein the determining step comprises:
a removing step in which the non-text image region is removed when it is determined.

7. The method according to claim 4, wherein conversion into binary information is implemented by removing color (RGB) information from the determined text image region and converting the determined text image region into a monochrome image.
